(19) United States
(12) Patent Application Publication
(10) Pub. No.: US 2004/0159826 A1
(43) Pub. Date: Aug. 19, 2004

(54) Mounting member for jack

(76) Inventors: Joseph J. Peschmann, Plover, WI (US); Kawa-She-Quoen Wm. Okerlund, Wittenberg, WI (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 10/368,854

(22) Filed: Feb. 19, 2003

(51) Int. Cl. B60S 9/02

(52) U.S. Cl. 254/420

(57) ABSTRACT

The present invention is directed to a mounting member for a jack. The mounting member includes a single die cast member having a jack engaging portion. The jack engaging portion is capable of being mounted to a jack tube having either a square or circular cross-section. The mounting member also includes a connecting portion integrally formed with the jack engaging portion. The connecting portion is capable of pivotal connection to an object to be supported with the jack.

### FIELD OF THE INVENTION

The present invention relates generally to a mounting member for a jack, and more particularly, to a mounting member for a jack tube for supporting an object.

### BACKGROUND OF THE INVENTION

Tube mount jacks are known in the art and are used for connecting to an object, such as a trailer frame, for the purpose of raising or lowering that object with a jack mechanism. Tube mount jacks are also known to swivel about the object connection so that the jack may pivot to an out-of-the-way position during non-use. Particularly, tube mount swivel jacks offer the convenience of a swivel mechanism with the durability necessary for commercial, agricultural, and industrial markets.

Generally, tube mount jacks are constructed from a tubular body containing the jack mechanism and having a jack mount member mounted thereon. The jack mount member is capable of telescopically receiving a mounting member that is mounted to the object, wherein the jack mount member may rotate relative to the mounting member. Therefore, the jack member can be pivoted between a stored position, generally parallel with the trailer frame and not engaging the ground, and a use position where the jack member engages the ground to lift the object.

Known jack mount members in the art are designed to mount to only a round jack tube or square jack tube, but not both. In particular, known jack mount members used for mounting to a round jack tube have a half-moon or semi-circular shape at one end. Such a shape allows the jack mount member to mount to a round jack tube having a similar or same contour. However, this type of jack mount member fails to properly mount to a square jack tube, as minimal contact would exist between the jack mounting member and the square jack tube for a proper mounting. In contrast, jack mount members for mounting to a square jack tube have a level edge at one end capable of contacting an edge of the square jack tube. The level edge of the jack mount member is then welded to an edge of the square jack tube. However, such a jack mount member cannot mount to a round jack tube because minimal contact would exist between the level edge of the jack mount member and the rounded surface of the round jack tube. Therefore, manufacturers must maintain an inventory of two jack mount members, one capable of mounting to a round jack tube and another capable of mounting to a square jack tube.

The manufacture of such mount members, jacks, and assorted parts has progressed very little over time. As has been known in the art for some time, the traditional jack mount member is fabricated from a generally square cross-section of tube welded to a circular cross-section of tube. For example, in U.S. Pat. No. 3,863,894, issued to Mansi et al., on Feb. 4, 1975, the traditional jack mounting member is disclosed. Jack mounting member 6 comprises two adjoining portions, a first portion 8 of generally square cross-section and a second portion 10 of generally circular cross-section. The first portion 8 is fabricated from a section of square steel tubing having one end closed and having the generally circular cross-sectional tubing welded to the closed end of the first portion 8. After welding the two pieces together, numerous secondary operations must be performed before the jack mount is ready for use, e.g. hole boring, stamping, finish grinding, etc. Such secondary operations are time consuming and add to the cost of the part through additional mechanical tooling and operations as well as additional labor costs. Once the numerous manufacturing operations are complete, the square cross-sectional portion may be welded to the jack tube and the circular cross-sectional portion may be connected to the trailer mounting member.

However, it is noted that the jack mounting member 6 is configured for a tube jack having a circular cross-section. In the present art, jack mounting members for mounting to square jack tubes are manufactured separately from jack mounting members for mounting to round jack tubes. Particularly, there are two separate configurations of the square cross-sectional member first portion 8, one configuration for mounting to a square jack tube and another configuration for mounting to a round jack tube. Because both square and round tube jacks are used in the art, manufacturers must maintain an inventory of both first portion configurations so that both square and round tube jacks can be manufactured.

U.S. Pat. No. 5,282,605, issued to Sauber on Feb. 1, 1994, discloses another type of mounting member known and used in the art. The mounting member or clamping bracket 24 is fixed to the jack column 22 and an outer retaining member 26 is fixed by bolts 25. The member 26 is received within a tubular outer support member 28 clamped to the trailer frame 12.

Finally, U.S. Pat. No. 6,302,381, issued to Roll on Oct. 16, 2001, and owned by the assignee of the present application, discloses a jack mounting bracket 30 that is welded to the jack 31 and is connected to the tongue-mounting bracket 20. The tongue or mounting bracket 20 is connected to the trailer, in a back-to-back engagement.

Accordingly, there exists a need for a jack mounting member that is simpler to manufacture. Particularly, there exists a need for a jack mounting member that requires fewer secondary operations during manufacture, resulting in less manufacture time and costs. There also exists a need for a jack mounting member that can be universally mounted to either a round or square jack tube.

### SUMMARY OF THE INVENTION

The present invention is directed to a mounting member for a jack used to support an object. The mounting member is a cast member so as to simplify the manufacture thereof. Casting eliminates the necessity of forming two steel parts, performing secondary operations on those parts, and welding those parts together to create the mounting member as is necessary with known mounting members. The cast member further comprises a jack engaging portion integral with a connecting portion.

The present invention is also directed to a mounting member for a jack used to support an object wherein the mounting member includes a jack-engaging portion that is capable of being welded to a jack tube having either a square cross-section or circular cross-section. The mounting member also includes a connecting portion that is integral with the jack engaging portion.

The present invention will be more fully described in the following written description with reference to the accompanying drawings.

### BRIEF DESCRIPTION OF THE DRAWINGS

The invention may take physical form in certain parts and arrangement of parts, a preferred embodiment of which will be described in detail in this specification and illustrated in the accompanying drawings that form a part thereof and wherein:

FIG. 1A is a perspective view of a jack 5 having a mounting member 10 connected to a tubular jack tube 30 having a rectangular cross-section.

FIG. 1B is a perspective view of a jack 5 having a mounting member 10 connected to a tubular jack tube 40 having a circular cross-section.

FIG. 2 is a perspective view of the mounting member 10.

FIG. 3 is a top plan view of the mounting member 10.

FIG. 4 is a right side elevational view of the mounting member 10, where the left side elevational view is substantially a mirror image of the right side elevational view.

FIG. 5 is a front elevational view of the mounting member 10.

FIG. 6 is a rear elevational view of the mounting member 10.

FIG. 7 is a cross-sectional view of the mounting member 10 taken along centerline 7-7 as shown in FIG. 6.

### DETAILED DESCRIPTION OF THE PREFERRED EMBODIMENTS

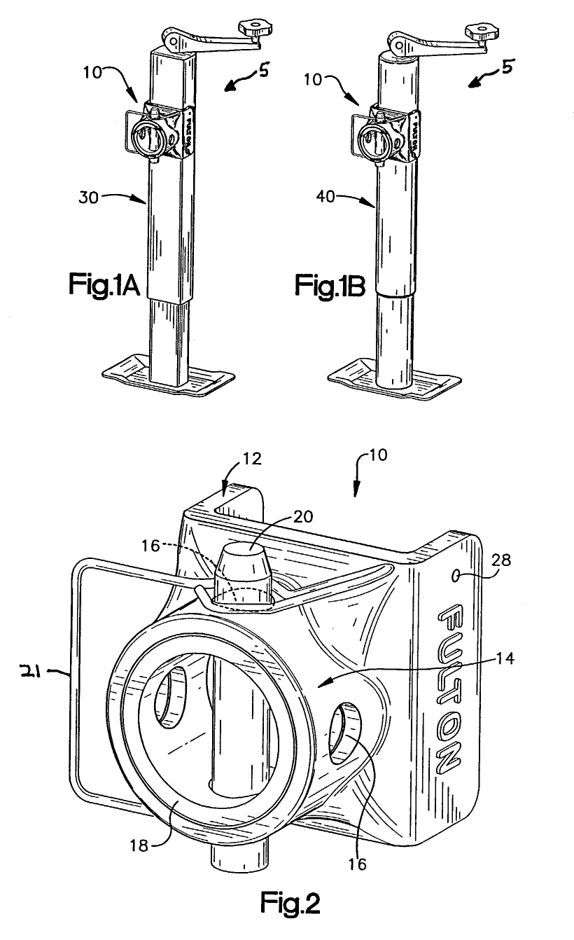

Referring now to the drawings, wherein the drawings are for the purposes of illustrating the preferred embodiment of the invention only and not for the purposes of limiting same, FIGS. 1A and 1B show a jack, generally designated as 5. FIG. 1A shows a mounting member 10 mounted to a jack tube 30 having a rectangular cross-section. FIG. 1B shows the mounting member 10 mounted to a jack tube 40 having a circular cross-section. Thus, as described in greater detail below, the present mounting member 10 can be mounted to a jack tube having either a rectangular or circular cross-section. The mounting member 10 can be universally mounted to the jack tubes 30,40 by any known attached means. Preferably the mounting member 10 is welded to jack tubes 30,40.

As best shown in FIG. 2, the mounting member 10 includes a jack engaging portion 12 and a connecting portion 14 integral with the jack engaging portion 12. Preferably, the mounting member 10 is a single-piece construction so that the connecting portion 14 is integral with the jack engaging portion 12. Preferably, the mounting member 10 is die cast so that the jack engaging portion 12 is integral with the connecting portion 14. Die casting a mounting member 10 eliminates the necessity of welding the previously separate jack engaging portions and connecting portions, drilling numerous apertures, stamping source identifying indicia thereon, and grinding the part to a smooth condition. Therefore, the die can be formed to provide appropriate apertures as well as providing identification indicia on the cast part. Further, because the part comprises a single cast part, the mounting member 10 exhibits additional strength characteristics over the previous welded connections of the prior art.

FIGS. 2-6 more fully show the connecting portion 14. The connecting portion 14 is capable of engaging to an object, such as a trailer frame, that is to be supported by the jack. A receiving end 18 is mounted to the object and connected to mounting member 10. Preferably the receiving end 18 is telescopically inserted into the connecting portion 14 and secured by a locking means. As shown, the receiving end 18 includes opposed apertures which align with opposed apertures 16 in the connecting portion 14 so that a locking member, such as pin 20, can be inserted therethrough so as to secure the mounting member 10 to the receiving end 18 and prevent telescopic removal of the jack 5 from the receiving end 18 and so as to prevent the rotation of the jack 5.

The connecting portion 14 has a generally circular cross-section, as shown in FIG. 2, although it is contemplated that the connecting portion 14 may have any geometric shape. The connecting portion 14 includes at least one aperture 16. Preferably, the connecting portion 14 includes a pair of apertures 16 and more preferably, the connecting portion 14 includes a plurality of apertures 16 spaced about 90° apart from one another, although more pairs of apertures could be provided with less than 90° of separation. The apertures 16 allow the mounting member 10 to be attached to the receiving end 18 as described above. By providing a connecting portion 14 having two pairs of apertures 16 offset by 90°, the mounting member 10 may be positioned in a use position as shown in FIGS. 1A and 1B or in a storage position wherein the jack 5 is rotated 90° relative to the object. The use position is where the jack is positionable substantially normal to the object, whereas the storage position is where the jack is positionable substantially parallel to the object. A locking means, such as a pin 20, can slide through one or more of the apertures in order to connect the connecting portion 14 to the object in either the use or storage position. Furthermore, the mounting member 10 may include one or more pin chain holes 28 where the pin 20 can be connected to the mounting member 10 so as to prevent loss of the pin 20. Locking member 21 is mounted to one end of pin 20 and fictionally connected to the opposite end of the pin 20 so as to prevent accidental disengagement of the pin 20.

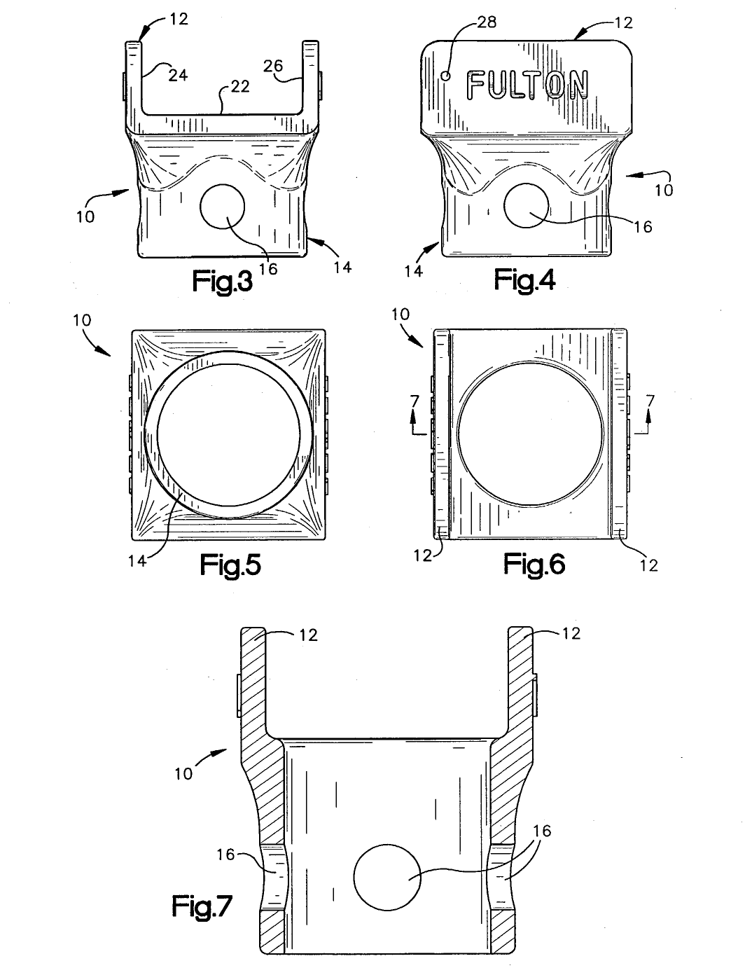

FIGS. 3, 4 and 7 more fully show the jack engaging portion 12 of the mounting member 10. The jack engaging portion 12 comprises a generally U-shaped portion and includes a bottom wall 22 and two upstanding side walls 24 and 26. The bottom wall 22 and upstanding side walls 24 and 26 allow the mounting member 10 to mount to a jack tube having either a rectangular cross-section or circular cross-section. Preferably, each wall 22, 24, and 26 contacts the jack tube and is capable of welded attachment thereto. The generally U-shaped jack engaging portion 12 is not limited to a truly rectangular shape and may be square shaped, a shape composed of three flat surfaces with rounded corners, or an elongated elliptical shape in which the upstanding walls can be either the long or short sides. The jack engaging portion 12 is attached by any known means to the jack tube, although it is preferred that upstanding walls 24 and 26 are welded to the jack tube. It is also preferred that the upstanding walls 24 and 26 are welded to opposing sides of the jack tube. Of course, it is contemplated that the jack engaging portion 12 can be connecting to the jack tube by any of a number of connecting means including screws, bolts, rivets, etc.

In operation, the connecting portion 14 of the mounting member 10 telescopically engages the receiving end 18 which is mounted to the object. The mounting member 10 is secured to the receiving end 18 by a pin 20, which slides through at least one aperture 16 in the connecting portion 14 and through at least one aperture in the receiving portion 18. Preferably, pin 20 is inserted through opposed apertures 16 in the connecting portion and through aligned apertures in the receiving portion 18 as shown in FIG. 2. The connecting portion 14 can be engaged to and is pivotable about the receiving end 18 so that the jack 5 is in either the use position or the storage position.

The invention has been described with reference to the preferred embodiment. Obviously, modifications and alternations will occur to others upon a reading and understanding of this specification. The claims as follows are intended to include all modifications and alterations insofar as they come within the scope of the claims or the equivalents thereof.

Having thus described the invention, what is claimed is:

1. A mounting member for a jack used to support an object, said mounting member comprising:
a cast member comprising a jack engaging portion integral with a connecting portion.

2. The mounting member of claim 1 wherein said jack engaging portion is capable of being mounted to a jack tube having a rectangular cross-section and a jack tube having a circular cross-section.

3. The mounting member of claim 1 wherein said jack engaging portion includes a bottom wall and at least one upstanding wall.

4. The mounting member of claim 3 wherein said jack engaging portion is generally U-shaped.

5. The mounting member of claim 1 wherein said connecting portion comprises a member having a generally circular cross-section.

6. A mounting member for a jack used to support an object, said mounting member comprising:
a jack engaging portion capable of connecting to a jack, said jack having either a square cross-section or circular cross-section;
a connecting portion integral with said jack engaging portion capable of connection to said object.

7. The mounting member of claim 6 wherein said mounting member is a die cast member.

8. The mounting member of claim 6 wherein a receiving portion is mounted to said object and said connecting portion is releasably mounted to said receiving portion.

9. The mounting member of claim 8 wherein said connecting portion is pivotal about said receiving portion.

10. The mounting member of claim 9 wherein said connecting portion includes at least one aperture capable of alignment with at least one aperture in said receiving portion wherein a mounting pin can be inserted so as to retain said connecting portion on said receiving portion.

11. The mounting member of claim 10 wherein said connecting portion and said receiving portion have at least a pair of opposed apertures therethrough for receiving a mounting pin therethrough.

12. The mounting member of claim 1 wherein said connecting portion has a plurality of apertures spaced 90° apart.

13. The mounting member of claim 6 wherein said jack connected to said jack engaging portion is pivotal between a storage position where said jack is positionable substantially parallel to said trailer frame and a use position where said jack is positionable substantially normal to said trailer frame.

14. A mounting member for a jack used to support a trailer frame, said mounting member comprising:
a single die cast member having a jack engaging portion capable of welding to an outer jack tube;
a connecting portion integral with said jack engaging portion capable of pivotal connection to a receiving portion welded to said trailer frame.

15. The mounting member of claim 14 wherein said jack engaging portion is welded at opposing sides of said outer jack tube.

16. The mounting member of claim 15 wherein said jack engaging portion includes a bottom wall and two upstanding walls, said upstanding walls welded to opposing sides of said outer jack tube.
